(19) United States
(12) Patent Application Publication
(10) Pub. No.: US 2002/0069253 A1
(43) Pub. Date: Jun. 6, 2002

(54) Multimedia data electronic mail system

(76) Inventors: Kimihiko Kazui, Kawasaki (JP); Masami Mizutani, Kawasaki (JP); Hideaki Watanabe, Kawasaki (JP); Eishi Morimatsu, Kawasaki (JP)

Correspondence Address: ROSENMAN & COLIN LLP, 575 MADISON AVENUE, NEW YORK, NY, 10022-2585, US

(21) Appl. No.: 09/933,600

(22) Filed: Aug. 21, 2001

(30) Foreign Application Priority Data
Dec. 1, 2000 (JP) 2000-367550

(51) Int. Cl. G06F 15/16

(52) U.S. Cl. 709/206; 709/219; 709/229

(57) ABSTRACT

A multimedia electronic mail system includes a multimedia data server, which stores multimedia data to transmit according to a request; a sending client having a mailer, which registers the multimedia data to the multimedia data server and indicates the identifiers of the multimedia data to a plurality of clients using an electronic mail; and a plurality of receiving clients, each of which has a mailer for receiving the electronic mail transmitted from the sending client, and obtains the multimedia data stored in the multimedia data server through a network. The multimedia data server includes retention period information on the multimedia data, and reference client information consists of identifiers of entire receiving clients which may possibly refer to the multimedia data, to control to delete the multimedia data according to the retention period information and the reference client information.

### FIELD OF THE INVENTION

The present invention generally relates to data communication in the fields of computer systems and multimedia communication, and more particularly a multimedia electronic mail system for transmitting a multimedia data including voice and image data (hereinafter referred to as AV data) to others via electronic mail.

### BACKGROUND OF THE INVENTION

There has been remarkable advance in the technologies of the Internet for interconnecting computers throughout the world, digital storages for storing vast amount of data, and multimedia processing for compressing or reproducing multimedia data. With the development of such technologies, it becomes widespread to make use of digital contents including voice and moving images.

For example, the following ways of use have become available: (1) replaying compressed audio data or moving image data recorded for hours in a form of CD (Compact Disc) or DVD (digital versatile disc) using a TV monitor or the like at home; (2) watching in real time live pictures being broadcast through the Internet through a computer connected thereto; and (3) sending to others through an electronic mail an AV data (multimedia data including voice and image) being taken using a digital home video camera. The above last example (3) may often be called a multimedia electronic mail, which is referred to in this description of the present invention.

Here, transmission data volume is an issue to be considered when exchanging a multimedia electronic mail. For example, when a video data for one minute is coded at the rate of 1.5 Mbps using ISO/IEC 11172-2 (MPEG-1 Video), the data amount reaches approximately 10 megabytes.

On the contrary, in an electronic mail being exchanged using the current Internet, the data amount is at most 1 megabyte or less per mail. When such large amount of data as video data mentioned above is transmitted to multiple persons, the system may well become frozen as a result of the overflowed storage capacity in a mail server for relaying the electronic mail

As a means to solve this problem, a method is disclosed in the official gazette of Japanese Unexamined Patent Publication No. Hei-9-35129, in regard to data communication equipment and a method therefor. According to this technique, an image data is stored in an AV data server. Instead of real image data being transferred within the electronic mail, reference information (namely an identifier of the image data stored in the AV server) is transmitted in the electronic mail.

On receipt of the electronic mail, a destination user, when necessary, obtains the AV data stored in the AV data server according to the identifier indicated in the received electronic mail. By means of downloading through the network, not being transferred within an electronic mail, malfunctioning of a mail server can be avoided.

More specifically, the following three configuration elements are required to realize a multimedia electronic mail system: (1) a sending client for registering a multimedia data (AV data) to an AV server and transmitting reference information of the AV data to other users via electronic mail. (2) an AV data server for storing and managing the AV data. (3) a receiving client for receiving the electronic mail and, upon request by the recipient, downloading the AV data entity from the AV data server.

Among above three elements, services of the AV data server playing a main role in the system is maintained by charging sending clients registering AV data for server usage fee. In the above-mentioned invention disclosed in the official gazette of Japanese Unexamined Patent Publication No. Hei-9-35129, the charging system is defined not on a uniform basis but on a variable bases depending on the size or retention period of the registered AV data.

Considering from the viewpoint of storage area reservation, it is a prerequisite that an AV data area in the AV data server is dynamically allocated on each AV data registration basis, instead of each predetermined area statically allocated for each user. The reason is that, when handling electronic mails basically consisting of temporary data, constant and fixed area allocation for each unspecified open user is redundant and therefore is not suitable to make full use of AV data storage area.

In other words, AV area management is a problem toward a smooth operation of the system of this kind. Needless to say, the capacity of AV data server area is finite. In order to make it possible to register new AV data at any time, it is necessary to delete old unwanted data properly from the AV data area to reserve for new data. At the same time, however, it must be considered that a user may refer to an AV data stored for downloading through the network.

It is inconvenient if an user received an identifier of an AV data and nevertheless the actual AV data does not exist any longer when the user accesses the AV data server. The system must be so designed as to avoid such situation as mentioned above.

In the technique disclosed in the aforementioned official gazette of Japanese Unexamined Patent Publication No. Hei-9-35129, there is shown a system by which an AV server can accept the AV data deletion control. However, a method against AV data area saturation, such as input reception restriction, is not given and therefore the above problem remains unsolved.

In regard to the deletion control against data which is possibly referred to by unspecified open users, a technique is disclosed in the official gazette of Japanese Unexamined Patent Publication No. Sho-63-291131. The disclosed technique is concerned with an electronic document management method in an interactive information handling system. In short, this technique is provided for electronic documents existing in a computer.

The user who generates and registers an electronic document is authorized to delete the document. Once a document is registered by a user, other users issue a ‘document copy request’ (DCR) to the system whenever the users want to use this electronic document.

When the system is to delete an electronic document because of an expired retention period or other reasons, the system transmits a deletion confirmation message to the user who registered the document. Document copy request information from a plurality of users is included in this deletion confirmation message. The user registering the message determines to perform such a process as generating duplications of the message to transmit to only users who belong to the same user group desiring to refer to the document, then to delete the original document concerned. In such a manner, the problem of deleting electronic document is solved.

However, the above-mentioned method disclosed in the Japanese Unexamined Patent Publication No. Sho-63-291131 is not suitable for a multimedia electronic mail service, in which only specified users refer to an AV data.

The reasons are that, firstly, when deleting an AV data stored in an AV data server, a certain operation is required by the user who generated the AV data. In general, however, the original AV data is stored in local equipment managed by the user who generated the document. Therefore, it is difficult for the user to consider about the necessity of maintaining the AV data stored in the AV data server.

Furthermore, essentially the permission is not needed because users who refer to a multimedia electronic mail are known by the sender of the electronic mail (in other words, to view the multimedia electronic mail is permitted by the sender). To conclude, the conventional method disclosed obliges users of a multimedia electronic mail service to conduct additional actions.

Secondly, according to the conventional method, it is necessary for a recipient of an electronic mail to issue a DCR (document copy request) prior to viewing an AV data stored in an AV data server. In the cases that the recipient does not read the electronic mail for a long time or forgets to send a DCR, an undesirable event may occur, for example the recipient cannot download the AV data for viewing because the AV data is already deleted from the AV data server.

### SUMMARY OF THE INVENTION

Accordingly it is an object of the present invention to provide a system to solve the aforementioned problems in such a manner that an AV data server identifies all clients who may refer to an individual AV data, and deletes the AV data concerned after recognizing that no client refers to the data any longer.

More specifically, a subsystem having the following function is provided in the system where when a sending client having an AV data registered in the AV data server transmits the AV data identifier described in an electronic mail to a plurality of clients, the sending client extracts the addresses (identifiers of the recipients) and an AV data identifier to indicate to the AV data server.

The subsystem is implemented in either of the following three cases, namely, a mailer provided in a sending client; a mail relay server; or a mailer provided in a receiving client. By means of this subsystem, irrespective of the implementation cases, the AV data server can recognize an identification (for example, mail address) of the client which possibly refers to each AV data.

Meanwhile, each plurality of receiving clients which receives the electronic mail obtains the AV data being referred to by the identifier from AV data server through the network.

When the receiving client decides the received electronic mail becomes unwanted any longer because the receiving client either has no interest in referring to the AV data or has already referred to the AV data concerned, the receiving client consequently manipulates to delete the electronic mail concerned using the mailer in the receiving client. As a result, the mailer automatically informs the AV data server that the AV data referred to by the identifier is not wanted any longer. Here, the information includes an identifier of the client concerned as well as the identifier of the AV data.

On receiving the information from a plurality of clients by which the relevant AV data is to be possibly referred to indicating the AV data being unwanted, the AV data server compares the client identifiers stored in the reference client information with the client identifiers received, to delete the entries corresponding to the received client identifiers.

At the time when the information indicating the AV data being unwanted is received from all relevant users, there exists no client identifier by which the AV data is possibly referred to. When the situation becomes this condition, the relevant AV data entry corresponding to the client identifier is deleted even before the retention period (defined by the sending client having registered the AV data, or by the AV data server) expires.

In the case that the retention period expires before receiving from all clients concerned the information indicating the AV data being unwanted, the fact of the expired retention period is informed to any client having not responded before the expiration. At the same time, an extension of the retention period is noticed to such clients. Here, the extension period is determined from the current condition of the storage occupancy in the AV data server so that the AV data server area may not be saturated or overflowed. If any reply requesting for extension is received from any of the client to which the aforementioned notification is sent, the system enables to extend the retention period according the prior notice.

Accordingly, with regard to the deletion of an AV data stored in the AV data server, any particular manipulation is not required by the user in the client having registered the AV data, thus eliminating the operational complexity. Also, this can solve such a possible problem that a user who wants to obtain an AV data cannot receive the data any longer because of the preceded deletion of the AV data, caused by a missing operation of indication from the user to the AV server.

Additionally, in this description, it is assumed that one user uses the system in each client. There may be a case, however, that a plurality of users in a client commonly use the system. In such a case, a separate identifier may well be allocated to each user.

Further features of the present invention will become more apparent by the following description of the embodiments with the accompanied drawings.

### BRIEF DESCRIPTION OF THE DRAWINGS

FIG. 1 shows an example of system configuration according to the present invention.

FIG. 2 shows an example of data format in management information storage equipment 15 of an AV data server.

FIG. 3 shows an example of a display screen to be displayed on a non-illustrated user monitor using an HTML data obtained by server communication portion 22.

FIG. 4 shows text contents of an electronic mail generated by a user using electronic mail equipment.

FIG. 5 shows a display screen displayed using an HTML browser.

FIG. 6 shows an example of display screen for a user presented by a mailer in receiving client 30 having received a multimedia electronic mail.

FIG. 7 shows an embodiment of a function provided in receiving client 30 for confirming a user whether the retention period is to be extended.

FIG. 8 shows an embodiment of a function provided in receiving client 30 for confirming a user whether the retention period is to be extended.

### DETAILED DESCRIPTION OF THE PREFERRED EMBODIMENTS

The preferred embodiments of the present invention are described hereinafter referring to the charts and drawings.

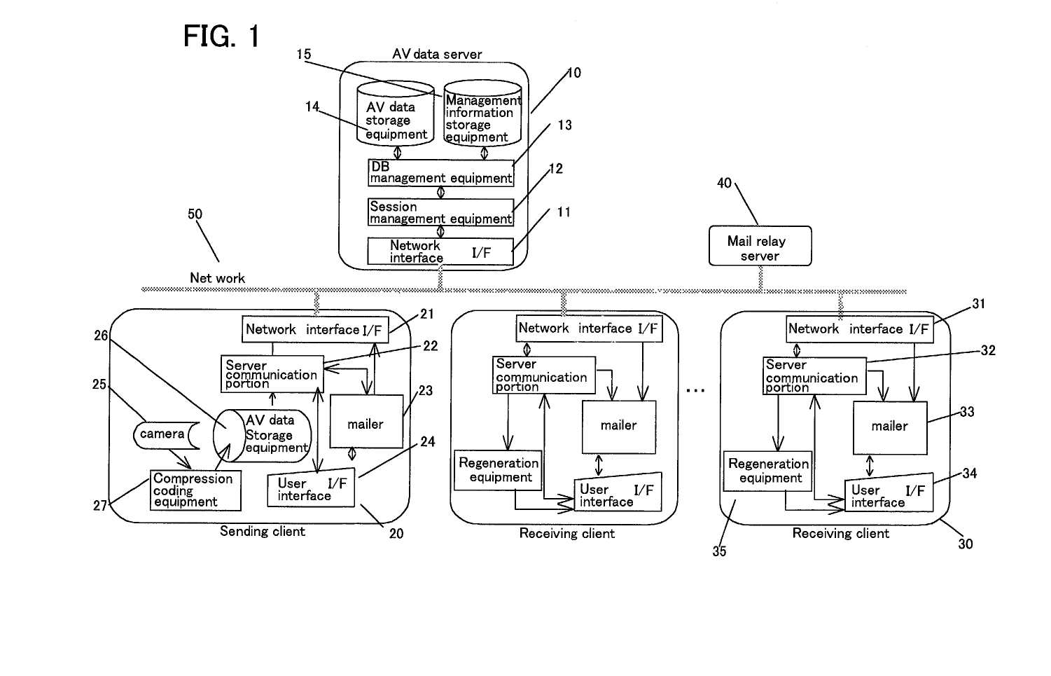

In FIG. 1, a system configuration according to the present invention is shown. An AV data server 10, a mail relay server 40 and a plurality of clients 20, 30 are interconnected through a network 50 such as the Internet.

As for clients 20, 30, a client functions as a sending client 20 when transmitting an AV data, and a client functions as a receiving client 30 when receiving an AV data.

AV data server 10 is provided with AV data storage equipment 14 for storing a plurality of an AV data with compressed code. In management information storage equipment 15, management information (a retention period, reference client information, etc.) in AV data storage equipment 14 is maintained.

Further, AV data server 10 includes database management equipment 13 to read, write or delete internal data maintained in both AV data storage equipment 14 and management information storage equipment 15, session management equipment 12, and a network interface 11.

Session management equipment 12 performs processing against various requests from sending client 20 and receiving client 30, such as a contents registration request and an AV data download request under the cooperation of database management equipment 13.

Session management equipment 12 functions as an HTTP (hypertext transfer protocol) server and an electronic mail server. More specifically, session management equipment 12 transmits HTTP messages, electronic mails, and AV data, responding to an electronic mail or an HTTP access originated from either sending client 20 or receiving client 30.

Sending client 20 is configured with a network interface 21, a server communication portion 22, a mailer 23, a user interface 24 for the input/output from/to a user, a camera 25 for capturing AV data, compression coding equipment 27 for compressing AV data, AV data storage equipment 26 for preserving the compressed AV data, etc.

Server communication portion 22 has a session management function being carried out at the time of AV data registration to AV data server 10, typically consisting of an HTML browser. When registering an AV data, server communication portion 22 downloads an HTML (hypertext markup language) data for registration from AV data server 10 using HTML, to send to a user through interface 24. (The HTML data mainly includes a form for user's input and transmission of an AV data to the AV data server.)

Mailer 23 has a function of generating an electronic mail. One typical example of mailer 23 is constituted by electronic mail equipment for dedicated use, having functions of editing text and sending/receiving an electronic mail using SMTP (simple mail transfer protocol)/POP (post office protocol).

Another typical example of mailer 23 is constituted by an HTML browser. In this case, an HTML data (form) for generating and sending an electronic mail is downloaded from AV data server 10 using HTML. Then content of the electronic mail (addressee and message text) is generated through user interface 24 by means of the HTML browser, to send to AV data server 10 using HTTP.

AV data server 10 interprets the received data and converts the data into a real electronic mail form to transmit to sending client 20 using, for example, SMTP.

On the other hand, receiving client 30 is constituted by network interface 31, server communication portion 32, mailer 33, user interface 34, and regeneration equipment 35.

Mailer 33 receives an electronic mail transmitted using, for example, SMTP, and also manages the received electronic mail, indicating the contents of the electronic mail to a user through user interface 34. Also, mailer 33 has a function of transmitting an HTML data contained in the electronic mail (for example, in MIME form) to the HTML browser provided in server communication portion 32.

Server communication portion 32 generates a message used for downloading an AV data from AV data server 10 as well as performs a session management.

More specifically, server communication portion 32 is the HTML browser which processes an HTML data contained in the electronic mail or an HTML data obtained from the AV data server using HTTP, to indicate to a user through user interface 34. Also, server communication portion 32 transmits a data to AV data server 10 according to a user input using HTTP.

Regeneration equipment 35 has a function of decoding the AV data downloaded from the AV data server using, for example, HTTP to hand over through user interface 34 so that the regenerated AV data can be displayed.

Mail relay server 40 relays a mail sent from sending client 20 to receiving client 30 in accordance with SMTP.

Network 50 is a network which interconnects AV data server 10, for sending client 20, receiving client 30 and mail relay server 40. Here, it is assumed that the data passing through the network is transmitted using TCP/IP (transport control protocol/internet protocol) or UDP (user datagram protocol: a form of connectionless data transmission).

[Management Information Storage Equipment]

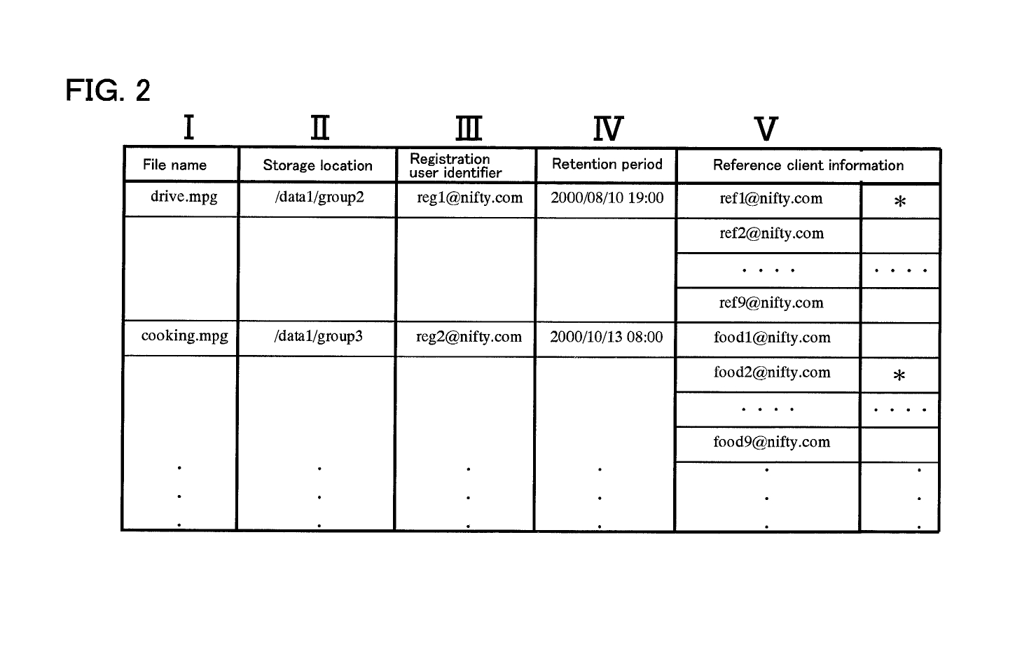

In FIG. 2, there is shown an example of data format in management information storage equipment 15 provided in AV data server 10.

In FIG. 2, an entire format of the table for storing data is shown. Column I represents AV data file names stored in Av data storage equipment 14. Column II represents locations of the AV data stored therein. Column III represents client identifiers having registered AV data, or electronic mail addresses according to this embodiment. Column IV represents retention period of each AV data.

Furthermore, column V consists of the left part which represents client identifiers which possibly refer to the AV data (electronic mail addresses in this embodiment) and the right part which represents any access or not being encountered from each client. (In this right part, it is also marked whether or not the notification for extending the retention period has been received, as explained later.) In FIG. 2, * is marked in the same column as the client identifier from which an access is performed.

For example, assuming that the name of AV data server on the Internet is “AV-serv.co.jp”, an AV data file name to be registered in the column I is “AV-serv.co.jp/datal/group2/drive.mpg”.

[AV Contents Registration]

An example of the AV contents registration in AV data server 10 originated by sending client 20 is explained hereafter.

First, in order to generate an HTML display screen to represent to the user who wants to register an AV data, a HTML browser functioning in server communication portion 22 acquires an HTML data prepared for AV data registration from AV data server 10, using URL (uniform resource locator) which was obtained beforehand by a predetermined means.

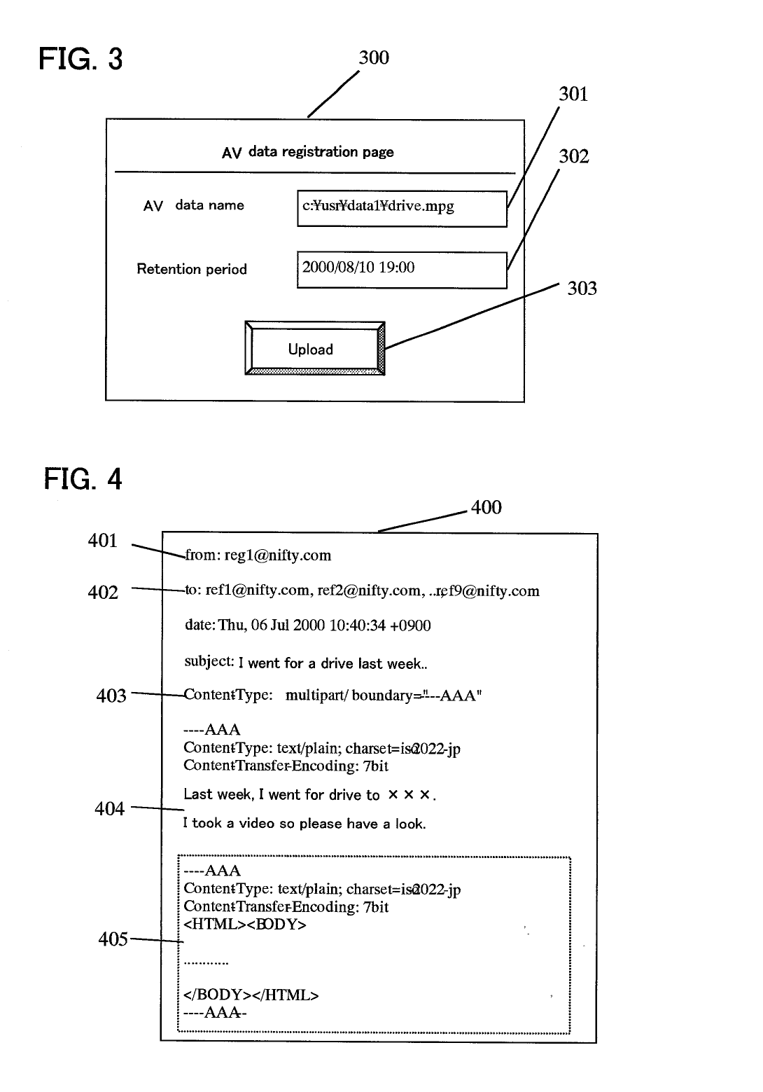

In FIG. 3, there is shown an example of display screen to be displayed on a user monitor (not shown) using the HTML data acquired by server communication portion 22. In a display screen 300, an input field 301 is provided for the user to input an AV data file name stored in AV data storage equipment 14. This input field can be prepared using an <INPUT> tag in HTML.

Another input field 302 is provided for inputting retention period of the AV data. Also an UPLOAD button 303 is provided. When this UPLOAD button is clicked, the HTML browser transmits the AV data file name, the retention period and the AV data to AV data server 10 using HTTP. The transmitted information are stored in management information storage equipment 15 of AV data server 10 in such a table format as shown in FIG. 2.

In the case the mailer of sending client 20 is constituted by independent electronic mail equipment, AV data server 10 transmits a URL of the registered AV data to sending client 20 in HTML data format using HTTP. [Multimedia Electronic Mail Transmission]

Hereinafter a case that sending client 20 transmits an electronic mail is explained. In FIG. 4, contents of an electronic mail generated by a user using electronic mail equipment is shown in a text format.

In the contents of an electronic mail 400, a ‘from:’ field 401 included in the header denotes a mail address (identifier) of sending client 20. A ‘to:’ field 402 in the header denotes a list of mail addresses (identifiers) of receiving client 30. The to: field is uniquely defined in the header, so that the mailer can recognize the each identifier in receiving client 30.

The description in a field 403 indicates that this electronic mail consists of a multi-part message. A field 404 is a text message of the electronic mail.

A field 405 is an HTML data. Between the tags <BODY> and </BODY>, there are described; (1) an HTML data for displaying a button for downloading an AV data, (2) an HTML data for displaying a button for declaring that the AV data is unwanted, and (3) information on a retention period.

In the HTML data shown in above (1), URL information (with a password) of the AV data is included. Also, in the HTML data shown in above (2), URL information (with a password) of the AV data is included. These HTML data are transmitted from AV data server 10 at the time the AV data is registered.

The mailer transmits the mail address of the sending user extracted from the electronic mail to AV data server 10 using, for example, an electronic mail. The mail address of AV data server 10 can be obtained from the URL indicated in the HTML data.

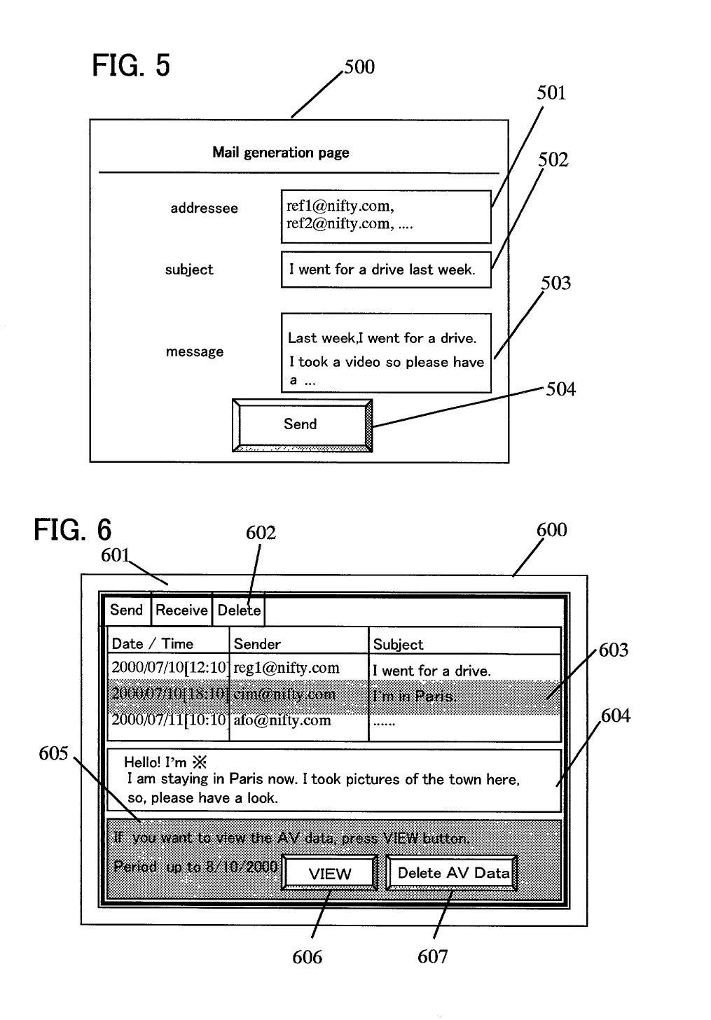

Now, another case is explained hereinafter, in which an HTML browser is used for interchanging information. After an AV data is registered, an HTML data to be used for generating an electronic mail is transmitted from AV data server 10. FIG. 5 shows a display screen in case of using the HTML browser.

In an HTML display screen 500 shown in FIG. 5, a field 501 denotes an input area for inputting mail addresses (identifiers) of the receiving users. A field 502 denotes an input area for inputting a subject, and a field 503 denotes an area for text message input.

A SEND button 504 is provided for deciding the transmission of an electronic mail. When this button 504 is depressed, the HTML browser transmits to AV data server 10 the mail addresses, the subject and the message respectively inputted into the above-mentioned fields, as well as the mail address of the sending user using HTTP.

AV data server 10 generates an electronic mail from the received information and an HTML data which includes a URL of the AV data (stored in AV data server 10 in this case) to transmit to receiving client 30 using SMTP.

Simultaneously, AV data server 10 stores the mail address of receiving client 30 in the corresponding part of management information storage equipment 15. The mailer of receiving client 30 transmits the own mail address thereof to AV data server 10 having the URL (Av-serv.co.jp) extracted from AV data identifier, using an electronic mails.

[Multimedia Electronic Mail Reception and AV Data Downloading]

In FIG. 6, there is shown a drawing which illustrates an example of a display screen supplied to a user by receiving client 30 after receiving the multimedia electronic mail.

An entire display screen 600 of the user interface includes a display window 601 of the mailer program. In display window 601, a received electronic mail list 602 is displayed. When either of the electronic mails is selected using a pointer such as a cursor, the selected line is highlighted using halftone dot meshing 603 or the like.

A display area 605 denotes a display screen generated by HTML browser in the mailer according to HTML data included in the selected mail. The retention period of the AV data is displayed in a text format. A button 606 is a VIEW button generated from the description of the HTML data. In this VIEW button 606, the URL corresponding to the AV data is described. When VIEW button 606 is depressed, a message is sent to AV data server 10 using HTTP, requesting for downloading the AV data.

According to the received message, AV data server 10 transmits the corresponding AV data to receiving client 30 using HTTP. The downloaded AV data is decoded by generation equipment 35 in receiving client 30 shown in FIG. 1. Then, a new image display window is generated, for example, in display screen 600 shown in FIG. 6, separately provided from display window 601 for the mailer.

Additionally, in case of the embodiment shown in FIGS. 5 and 6, the system is constructed so that a password is added to the URL of the AV data. This password is generated by AV data server 10 to be retained in a password area added to each AV data entry in management information storage equipment 15.

On receiving a request for downloading AV data from receiving client 30 using HTTP, AV data server 10 compares the mail address and the password of receiving client 30 having sent the request with the corresponding data stored in management information storage equipment 15. AV data is downloaded only in case that the comparison result coincided.

Accordingly, it is possible to prevent other clients having not received the multimedia electronic mail from illegally downloading the AV data concerned. The reason for this provision is that, although other clients do not know essentially the exact URL of the AV data, a case may happen that a client accidentally inputs a URL which actually exists during various trial actions.

Furthermore, a DELETE button 602 is provided for deleting a mail, as shown in FIG. 6. When this DELETE button 602 is depressed, an electronic mail being previously selected and highlighted with halftone dot meshing 503 is deleted. At this time, when the mail to be deleted contains an AV data in HTML format, the mailer notifies AV data server that receiving client 30 does not refer to the AV data any longer, using an electronic mail.

The contents of the electronic mail includes an identifier which indicates the message declaring the relevant AV data being unwanted, an identifier of AV data, and identifier of receiving client 30 respectively described in a text format.

In case that the mailer has no function of automatic transmission of the message declaring that the AV data is unwanted as mentioned above, the message declaring the AV data unwanted is transmitted by depressing a ‘DELETE AV DATA’ button 607 shown in FIG. 6. This ‘DELETE AV DATA’ button is generated from HTML data in a similar manner to display 605.

[Extension of Retention Period]

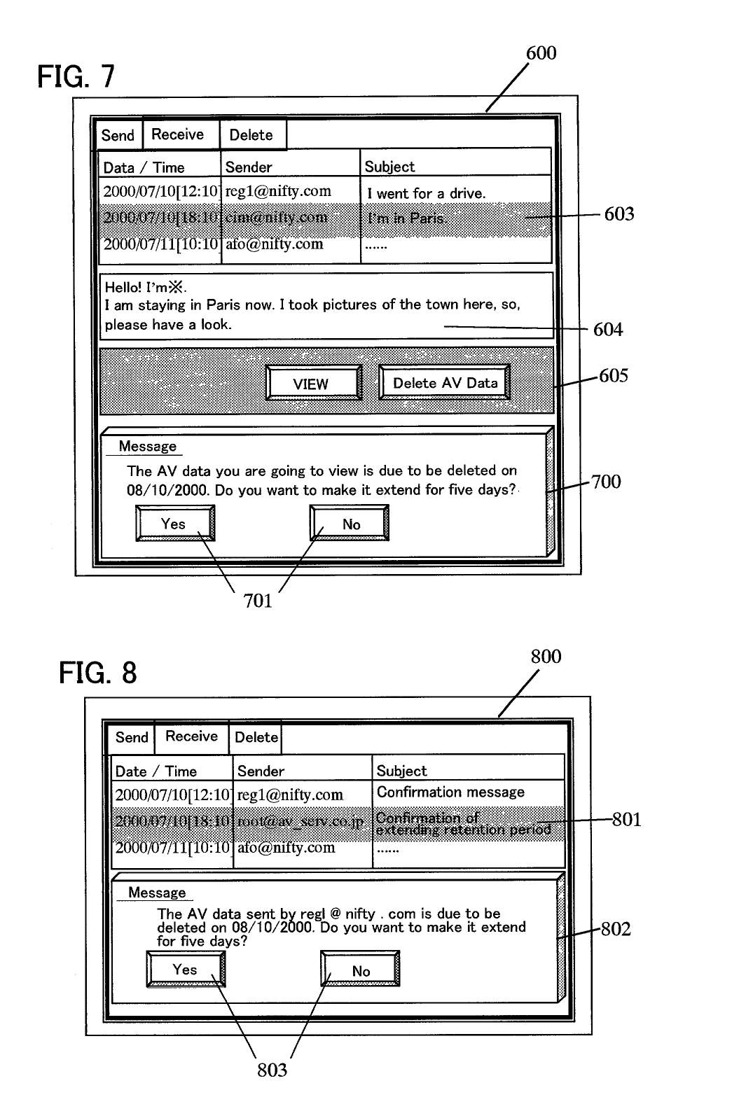

In FIG. 7, there is shown an example of a function provided in receiving client 30 for confirming a user's intention to extend the retention period of the AV data.

While receiving client 30 is browsing a plurality of multimedia electronic mails using message screen 700 of the mailer, the mailer compares the retention period described in HTML data of each multimedia electronic mail with current date and time. As a result of this comparison, if there exists an electronic mail of which expiration date is, for example, one day before the current date, the mailer highlights the corresponding electronic mail (as shown by 603 in FIG. 6). At the same time the mailer generates a message screen 700.

This message screen 700 is generated by the HTML browser provided in the mailer using HTML data. In this display screen, such a text as shown in the figure is displayed to confirm whether or not the extension of the retention period is desired. Also, YES/NO selection buttons 701 is displayed. Only in case YES is selected, the mailer notifies AV data server of the extension of the retention period by an electronic mail. As the format of this electronic mail, a text format is used, as an example. The mail includes an identifier indicating the message requesting extension of the retention period, the duration of extension, an AV data identifier, and an identifier of receiving client.

In FIG. 8, there is shown an example of a function of confirming the extension of the retention period to a user by receiving client 30.

As a result of inspecting each data stored in management information storage 15 by AV data server 10, in case that only one day is left as a retention period, a confirmation message 800 for confirming the extension of the retention period is transmitted to a reference client described in the reference client information. This message is transmitted by means of an electronic mail which includes HTML data.

In FIG. 8, when receiving client 30 opens this mail, the message-contents (HTML data) is displayed by the HTML browser in the mailer. The contents of HTML data and the behavior therefor is similar to the case of message screen 700 shown in FIG. 7. The file of which retention period is to be extended is highlighted by means of halftone dot meshing 801. In the HTML data, there is described the mail address of sending client 20 having transmitted the multimedia electronic mail.

In regard to the retention period of the file displayed with halftone dot meshing 801, confirmation buttons 803 are displayed in a confirmation message 802, requesting the user to confirm whether or not the retention period is required for extension.

[Report to Sending Client]

Before AV data server 10 deletes the AV data, the reference client information is inspected so as to obtain a list of receiving clients 30 (the reference client information registered in column V shown in FIG. 2) which supplied neither a message indicating the AV data unwanted, nor a request for the extension of the retention period. This information is transmitted to sending client (of which identifier is obtained from column III shown in FIG. 2) by, for example, an electronic mail having a text format.

Through the above description, it is assumed that one user is assigned for one client 30. There may be a case that a plurality of users are commonly assigned for one client. In such a case, separate identifiers may be allocated to the individual users.

The embodiments having been described above according to the drawings, the present invention enables to prevent users of a multimedia electronic mail system from receiving such inconvenience that an AV data desired by a user to view or listen to has already been deleted from the system.

According to the present invention, AV data stored in the AV data server can properly be deleted, enabling to continue the operation for a long term without encountering overflow and the like of the storage of the AV data server.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A multimedia electronic mail system comprising:
a multimedia data server for storing a multimedia data to transmit according to a request;
a sending client having a mailer, which registers said multimedia data to said multimedia data server and indicates the identifiers of said multimedia data to a plurality of clients using an electronic mail; and
a plurality of receiving clients each having a mailer for receiving said electronic mail transmitted from said sending client, for obtaining said multimedia data stored in said multimedia data server through a network,
wherein said multimedia data server includes retention period information on said multimedia data, and reference client information consisting of identifiers of entire receiving clients which may possibly refer to said multimedia data, to control to delete said multimedia data according to said retention period information and said reference client information.

2. The multimedia electronic mail system according to claim 1, wherein said multimedia data stored in said multimedia data server is deleted when either the number of receiving clients having a possibility of referring to said multimedia data becomes zero or the preset retention period of said multimedia data has expired.

3. The multimedia electronic mail system according to claim 2 wherein, when said sending client transmits an electronic mail containing the multimedia data identifier to said plurality of receiving clients, said mailer in the sending client indicates to said multimedia data server both said multimedia data identifier and the identifiers of said plurality of receiving clients.

4. The multimedia electronic mail system according to claim 2, further comprising a mail relay server for relaying an electronic mail transmitted from a sending client, wherein, when relaying said electronic mail, said mail relay server analyzes the received electronic mail contents to obtain said multimedia data identifier and the identifiers of said plurality of receiving clients to indicate to said multimedia data server.

5. The multimedia electronic mail system according to claim 2 wherein said each plurality of receiving clients analyzes the contents of the received electronic mail to obtain said multimedia data identifier to indicate to said multimedia data server together with said receiving client identifiers

6. The multimedia electronic mail system according to claim 3, wherein
when a user in said each receiving client determines the received mail being unwanted any longer and desires to delete, said receiving client indicates to said multimedia data server that said multimedia data corresponding to the identifier contained in the received electronic mail is no longer unwanted, and,
said multimedia data server updates the reference client information corresponding to said multimedia data based on said indication received from said received client.

7. The multimedia electronic mail system according to either of claims 1 wherein
said electronic mail transmitted from said sending client contains a retention period of said multimedia data,
said receiving client is provided with a means to confirm, on receipt of said electronic mail, the users therein whether or not said retention period is to be extended before the retention period expires,
when a request to extend said retention period is issued by a user, said request is transferred with said multimedia data identifier to said multimedia data server, and
said multimedia data server, upon receiving said request from said receiving client, updates the retention period information of said multimedia data corresponding to said received multimedia data identifier.

8. The multimedia electronic mail system according to either of claims 1 to 6 wherein
said multimedia data server indicates the retention period information to the entire receiving clients described in said reference client information, prior to the expiration of said retention period,
said receiving client provides a means to confirm before the expiration of retention period whether or not said retention period is to be extended,
a request for extending said retention period issued by said user is transferred with said multimedia data identifier.to said multimedia data server, and
said multimedia data server, upon receiving said request from said receiving client, updates the retention period information of said multimedia data corresponding to said received multimedia data identifier.

9. The multimedia electronic mail system according to claim 8 wherein said multimedia data server indicates to said sending client the information on a receiving client having issued no indication whether the multimedia data concerned is unwanted any longer nor a request for extending the retention period, in spite of having received an electronic mail from said sending client.

10. The multimedia electronic mail system according to claims 9 wherein
said multimedia data server manages a password for each multimedia data to transfer to the sending client,
said sending client, when transmitting a multimedia electronic mail, transmits said password as well,
said receiving client, when obtaining said multimedia data from said multimedia data server, transmits said password and the receiving client identifier to said multimedia data server, and
said multimedia data server compares said password and said receiving client identifier received from said receiving client with the corresponding data stored in said management information storage equipment, and permits said receiving client to acquire said multimedia data only in case the comparison result coincided.
